(19) United States
(12) Patent Application Publication
(10) Pub. No.: US 2026/0303909 A1
(43) Pub. Date: Oct. 1, 2026

(54) USING SEGMENT SIZE INFORMATION TO OPTIMIZE MEDIA TITLE STREAMING

(71) Applicant: NETFLIX, INC., Los Gatos, CA (US)

(72) Inventors: Christopher Alan NEWTON, North Richland Hills, TX (US); Mark WATSON, San Francisco, CA (US); Wei WEI, Plano, TX (US)

(21) Appl. No.: 19/403,638

(22) Filed: Nov. 28, 2025

Related U.S. Application Data
(60) Provisional application No. 63/780,111, filed on Mar. 28, 2025.

(51) Int. Cl. H04N 21/462; H04N 21/2187

(52) U.S. Cl. CPC H04N 21/4621; H04N 21/2187

(57) ABSTRACT

In various embodiments, a computer-implemented method for updating configurations of endpoint devices when streaming media titles includes receiving a first encoding derived from a first segment of audiovisual content in conjunction with receiving size data corresponding to one or more encodings of a second segment of audiovisual content, and updating a configuration of an endpoint device to cause the endpoint device to receive a second encoding derived from the second segment of audiovisual content based on the size data when streaming a media title.

### CROSS-REFERENCE TO RELATED APPLICATIONS

This application claims the benefit of U.S. Provisional Application titled “TECHNIQUES FOR MANAGING SEGMENT SIZE INFORMATION IN STREAMING MEDIA APPLICATIONS” filed on Mar. 28, 2025, and having Serial No. 63/780,111. The subject matter of this related application is hereby incorporated herein by reference.

### BACKGROUND

### Field of the Various Embodiments

Embodiments of the present disclosure relate generally to computer science and video processing and, more specifically, to using segment size information to optimize media title streaming.

### Description of the Related Art

Modern streaming services typically implement cloud-based networks of computer systems to stream audiovisual content associated with media titles to endpoint devices. The media titles can be pre-recorded in advance or correspond to live events occurring in real time. An architecture of a given cloud-based network often includes one or more content sources, one or more encoding pipelines, one or more packagers, one or more origin servers, and a content delivery network (CDN). In such an architecture, the content sources generate raw audiovisual content and distribute such content to the encoding pipelines. The encoding pipelines encode the raw audiovisual content into a compressed format and transmit encoded audiovisual content to the packagers. The packagers prepare the encoded audiovisual content for playback on various downstream endpoint devices and provide the packaged audiovisual content to the origin servers. The origin servers store the packaged audiovisual content and distribute such content to the CDN. The CDN includes a hierarchy of geographically distributed CDN nodes that distribute the content to nearby endpoint devices.

During streaming of a given media title, an endpoint device typically requests discrete segments of audiovisual content from the CDN. In certain streaming configurations, such as live streaming, each segment of audiovisual content has a fixed duration, such as two seconds. Accordingly, the endpoint device issues requests for segments of audiovisual content at regular intervals, such as every two seconds, in order to maintain a continuous stream of media content. Although sequential segments may have the same duration, sequential segments often have significantly different sizes for various reasons. For example, if a given scene of the media title lacks dynamic content for some period of time, the corresponding segments of audiovisual content may be highly compressible during that time, resulting in a relatively small segment size. However, if scene complexity suddenly increases, segment size would need to increase as well in order to accurately capture the increased complexity.

Certain types of endpoint devices need to preallocate buffer space for segments of audiovisual content before issuing requests for those segments. However, because segment size can vary dramatically between segments, the amount of buffer space to allocate cannot be accurately predicted. To address this issue, such endpoint devices are configured to issue a HEAD request or a limited size GET request for a subsequent segment in order to determine the size of the segment. Based on the determined size, the endpoint device preallocates the buffer space, and then issues the request for the subsequent segment. This approach is generally inefficient, however, because multiple requests have to be made for each individual segment, thereby wasting network resources. In addition, under certain conditions, the subsequent segment can be too large to download within the necessary timeframe, potentially causing rebuffering or other discontinuities.

As the foregoing illustrates, what is needed in the art is a more effective technique for requesting segments of audiovisual content.

### SUMMARY

In various embodiments, a computer-implemented method for updating configurations of endpoint devices when streaming media titles includes receiving a first encoding derived from a first segment of audiovisual content in conjunction with receiving size data corresponding to one or more encodings of a second segment of audiovisual content, and updating a configuration of an endpoint device to cause the endpoint device to receive a second encoding derived from the second segment of audiovisual content based on the size data when streaming a media title.

At least one technical advantage of the disclosed techniques relative to the prior art is that the disclosed techniques enable endpoint devices to avoid having to transmit multiple requests for each segment of audiovisual content. Accordingly, network bandwidth and processing resources need not be wasted issuing superfluous requests. Another technical advantage of the disclosed techniques relative to the prior art is that endpoint devices can more effectively select between different encodings of segments of audiovisual content at different bitrates, thereby allowing endpoint devices to maximize streaming quality while reducing the risk of rebuffering. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments; and

FIG. 4 is a more detailed block diagram of the endpoint device of FIG. 1, according to various embodiments;

FIG. 5 illustrates a network infrastructure that can be used to distribute audiovisual content to the endpoint devices of FIG. 1, according to various embodiments;

FIG. 6 illustrates how the endpoint device of FIG. 5 uses segment size information when requesting segments of audiovisual content, according to various embodiments; and

FIG. 7 is a flow diagram of method steps for using segment size information when requesting segments of audiovisual content, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

During streaming of a given media title, an endpoint device typically requests discrete segments of audiovisual content from a CDN. In certain streaming configurations, such as live streaming, the different segments of audiovisual content have a fixed duration, such as two seconds, but can have sizes that vary significantly and unpredictably from one segment to the next. The unpredictable nature of segment sizes can complicate streaming for endpoint devices that need to preallocate buffer space for a given segment before issuing a request for that segment. Such endpoint devices typically need to issue a HEAD request or a limited size GET request to determine the size of the next segment, preallocate buffer space based on the determined size, and then issue the request for that segment. However, this approach is generally inefficient because multiple requests must be made for each individual segment, thereby wasting network resources. Furthermore, under certain conditions, the subsequent segment can be too large to download within the necessary time frame, potentially causing rebuffering or other discontinuities.

To address these issues, an endpoint device issues a request for an encoding of a current segment of audiovisual content and receives, in response, the requested encoding along with size data associated with various encodings of a subsequent segment of audiovisual content at different bitrates. The endpoint device can then allocate buffer space for an encoding of the subsequent segment of audiovisual content before issuing a request for the encoding. The size data indicates one or more different sizes for one or more different encodings of the subsequent segment corresponding to several different bitrates. Based on current network conditions and currently available storage resources, the endpoint device can select an appropriate encoding of the subsequent segment to request that minimizes network latency, optimizes buffer usage, and maximizes streaming quality. In various embodiments, the endpoint device can select a particular encoding of the subsequent segment first, modify the current bitrate as needed, and then allocate the buffer space to accommodate downloading and buffering the encoding of the subsequent segment at the modified bitrate.

At least one technical advantage of the disclosed techniques relative to the prior art is that the disclosed techniques enable endpoint devices to avoid having to transmit multiple requests for each segment of audiovisual content. Accordingly, network bandwidth and processing resources need not be wasted issuing superfluous requests. Another technical advantage of the disclosed techniques relative to the prior art is that endpoint devices can more effectively select between different encodings of segments of audiovisual content at different bitrates, thereby allowing endpoint devices to maximize streaming quality while reducing the risk of rebuffering. These technical advantages provide one or more technological advancements over prior art approaches.

### System Overview

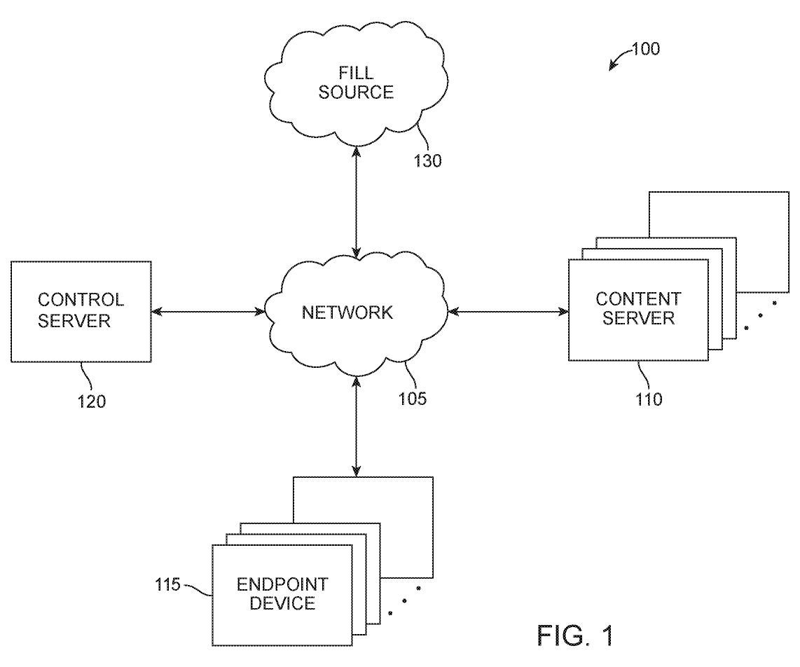

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

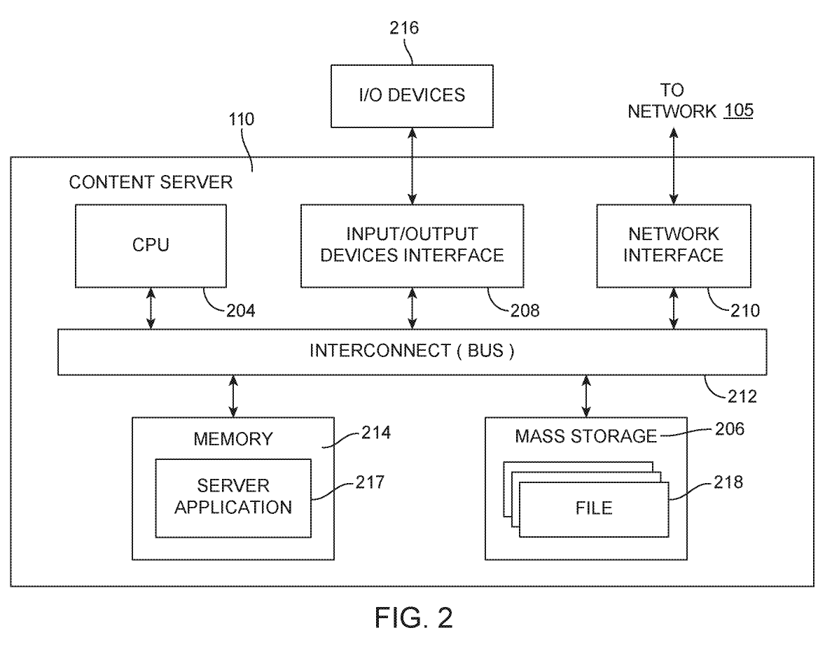

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

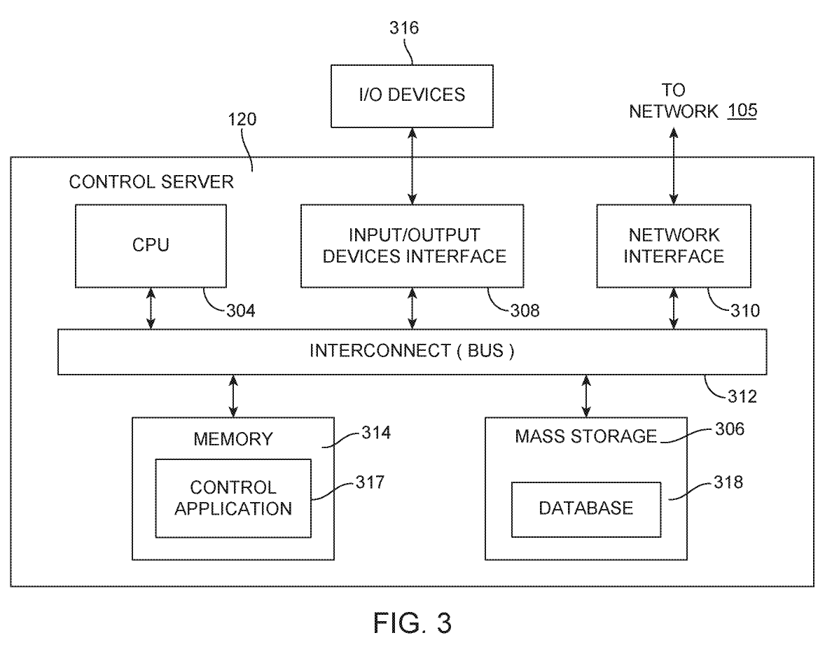

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

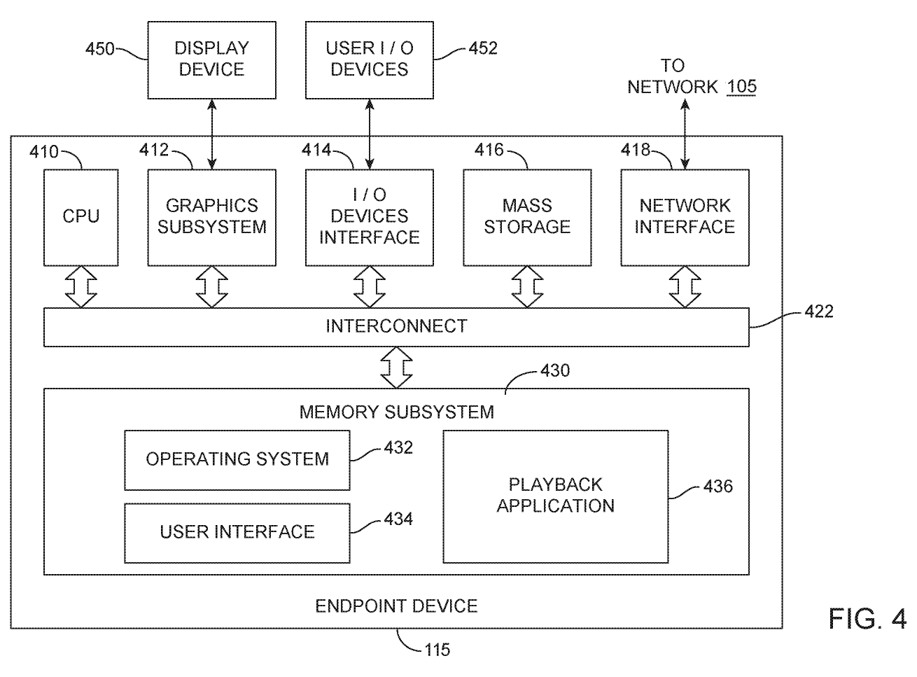

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

### Media Distribution Pipeline

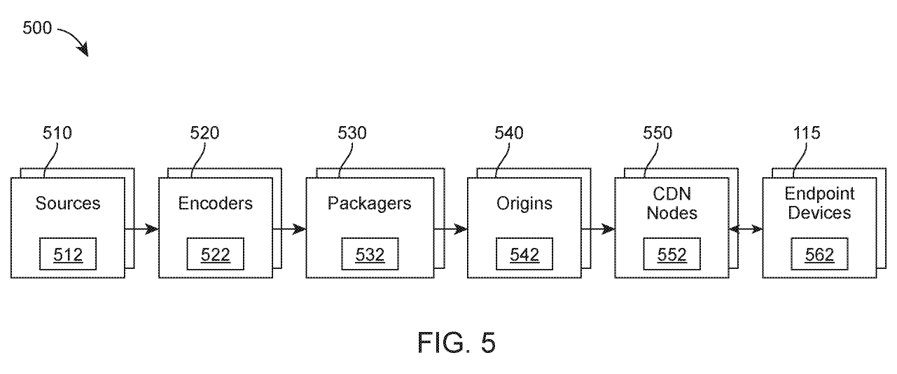

FIG. 5 illustrates a network infrastructure 500 that can be used to distribute audiovisual content to the endpoint devices of FIG. 1, according to various embodiments. As shown, the network infrastructure 500 includes one or more sources 510, one or more encoders 520, one or more packagers 530, one or more origins 540, one or more content delivery network (CDN) nodes 550, and one or more endpoint devices 115. The network infrastructure 500 is configured to generate, process, and distribute segments of audiovisual content to endpoint devices 115, where a given segment of audiovisual content includes one or more frames of audio data and/or video data and corresponds to any given duration of time.

The network infrastructure 500 may form any technically feasible portion of, or extension to, the network infrastructure 100 shown in FIG. 1. Further, various components of the network infrastructure 500 can be implemented via the different components of the network infrastructure 100 described above in conjunction with FIGS. 1-4. In particular, in various embodiments, origins 540 may be implemented via one or more fill sources 130, and/or CDN nodes 550 may be implemented via one or more content servers 110. Various components of the network infrastructure 100 and/or network infrastructure 500 may form a portion of a control plane, such as the control server 120, for example and without limitation, while other components of the network infrastructure 100 or network infrastructure 500 may form a portion of a data plane, such as the origins 540, for example and without limitation.

In operation, the network infrastructure 500 processes audiovisual content when streaming media titles to endpoint devices 115. A given media title can correspond to a live event occurring in real time or be pre-recorded at an earlier time. Accordingly, the network infrastructure 500 can support both live streaming configurations and video on demand (VOD) configurations. In a live streaming configuration, audiovisual content associated with a media title is recorded in real time at a broadcast location where a live event is occurring and then subsequently encoded, packaged, and distributed to endpoint devices for real-time playback. In this configuration, a given source 510 generally corresponds to a control center associated with the broadcast location that coordinates the production of audiovisual content at the broadcast location. In a VOD configuration, audiovisual content corresponding to a given media title is pre-recorded and stored by the sources 510 prior to encoding, packaging, and subsequent distribution to the endpoint devices 115.

In either of the above-described streaming configurations, the sources 510 distribute raw frames 512 of audiovisual content to the encoders 520. Upon receipt of the raw frames 512 of audiovisual content, the encoders 520 encode the raw frames of audiovisual content into encoded frames 522 of audiovisual content and provide the encoded frames 522 to the packagers 530 via one or more encoded video streams. The packagers 530 perform various packaging operations to prepare the encoded frames 522 for downstream decoding and output by endpoint devices 115, thereby generating packaged frames 532 of audiovisual content. The packagers 530 transmit the packaged frames 532 to the origins 540, which provide location-based storage of packaged frames 532 as compressed objects 542. The origins 540 distribute the compressed objects 542 to the CDN nodes 550. The CDN nodes 550 reside within a global CDN network and are geographically distributed at edge locations proximate to different endpoint devices 115. The CDN nodes 550 are configured to store cached objects 552 representing different copies of compressed objects 542. Upon request, one or more CDN nodes 550 transmit one or more cached objects 552 to endpoint devices 115 in order to support the streaming of media titles. A given endpoint device 115 performs a decoding operation with the received object(s) to generate decoded frames 562 of audiovisual content. Decoded frames 562 of audiovisual content can then be output to the user via a display device.

In various embodiments, multiple sources 510 are coupled to multiple downstream encoders 520, multiple encoders 520 are coupled to multiple downstream packagers 530, multiple packagers 530 are coupled to multiple downstream origins 540, multiple origins 540 are coupled to multiple downstream CDN nodes 550, and multiple CDN nodes 550 are coupled to multiple downstream endpoint devices 115. Accordingly, the network infrastructure 500 forms a distributed content generation and distribution system.

In one embodiment, the network infrastructure 500 may process segments of audiovisual content having a fixed duration, such as two seconds, for example and without limitation. In this configuration, any given segment of audiovisual content may include portions of one or more video streams and/or portions of one or more audio streams that are processed by successive components of the network infrastructure 500. In various other embodiments, segments of audiovisual content may have a variable duration that changes over the course of any given media title. In some embodiments, any given component of the network infrastructure 500 may be configured to complete all processing operations associated with any given segment of audiovisual content within a time frame that is proportional to the duration of any given segment, thereby supporting the ability to stream media titles associated with live events in real time and with minimal delay. Segments of audiovisual content can be organized into various tracks that include specific types of media, including a video track, an audio track, a subtitles track, or an event track, among others.

### Using Segment Size Information to Optimize Media Title Streaming

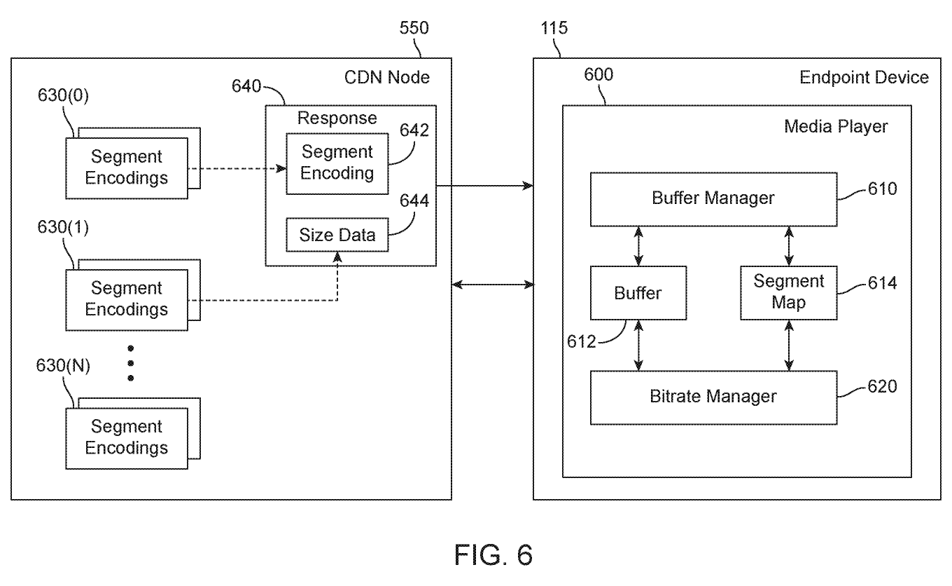

FIG. 6 illustrates how the endpoint device of FIG. 5 uses segment size information when requesting segments of audiovisual content, according to various embodiments. As shown, the endpoint device 115 includes a media player 600 that includes a buffer manager 610 and a bitrate manager 620. The buffer manager 610 and the bitrate manager 620 are both coupled to a buffer 612 and a segment map 614. The media player 600 is a software application that is configured to stream media titles. A given media title can be pre-recorded at a previous time or correspond to a live event occurring in real time. In some embodiments, the playback application 436 of FIG. 4 is configured to instantiate one or more media players 600 in order to stream one or more media titles. When streaming a media title, the media player 600 issues requests for encodings of discrete segments of audiovisual content from a CDN node 550 and can then output decoded audiovisual content via a display device, such as the display device 450.

As also shown, the CDN node 550 includes segment encodings 630(0) and 630(1) through 630(N). The segment encodings 630 collectively represent sequential segments of audiovisual content associated with a media title. For example, and without limitation, the segment encodings 630(0) could include audiovisual content associated with a first segment of the media title, while the segment encodings 630(1) could include audiovisual content associated with a subsequent segment of the media title. In addition, each of the segment encodings 630 includes one or more encodings of a corresponding segment of audiovisual content at a particular bitrate. For example, and without limitation, the set of segment encodings 630(0) could include an 8 megabits per second (Mbps) encoding of a particular segment of audiovisual content and a 12 Mbps encoding of the particular segment of audiovisual content. The various sets of segment encodings 630 are configured in the manner described to support adaptive streaming techniques. As is known in the art, adaptive streaming techniques allow a client device to request discrete segments of audiovisual content at different bitrates when streaming a media title, thereby allowing the client device to respond to changing network conditions while supporting the continuous delivery of audiovisual content. In some embodiments, the specific segment encodings included within any given set of segment encodings 630 correspond to a bitrate ladder associated with the media title being streamed.

In operation, the media player 600 issues requests to the CDN node 550 for segment encodings at a particular bitrate, and the CDN node 550 issues responses to those requests that include the relevant segment encodings. In the exemplary configuration shown, the CDN node 550 generates a response 640 that includes a segment encoding 642 that is extracted from the set of segment encodings 630(0). The segment encoding 642 has a particular bitrate that corresponds to the current bitrate at which the media player 600 streams the media title. In generating the response 640, the CDN node 550 also includes size data 644 indicating the sizes of some or all of the segment encodings 630(1) associated with a subsequent segment of the media title. For example, and without limitation, the size data 644 could indicate the size of an 8 Mbps encoding of the subsequent segment of the media title as well as the size of a 12 Mbps encoding of the subsequent segment of the media title.

When outputting audiovisual content associated with the segment encoding 642 at a given bitrate, the media player 600 can use the size data 644 to allocate buffer space for a subsequent segment encoding associated with the subsequent segment of the media title. This approach obviates the need to issue an extra request specifically to determine the size of that subsequent segment encoding. The media player 600 can also adjust the current bitrate based on the size data, as needed, in order to adapt to network constraints, media player 600 constraints, and/or endpoint device 115 constraints. This approach facilitates the continuous delivery of audiovisual content and reduces the risk of rebuffering. These techniques can also be implemented in conjunction with one another, as described in greater detail below.

In the example shown, upon receipt of the response 640, the buffer manager 610 stores the segment encoding 642 in the buffer 612 in preparation for output via the display device 450. The buffer manager 610 then updates the segment map 614 based on the size data 644. The segment map 614 is an array of values that indicates the size of each encoding of any given segment of audiovisual content included in the media title. The bitrate manager 620 then evaluates the segment map 614 in conjunction with various metrics that represent network conditions and/or the operational state(s) of the media player 600 and/or the endpoint device 115. Such metrics can indicate the currently available network bandwidth, the current network latency, the currently available processing resources, and/or the currently available memory resources, among others. Based on such metrics, and based on the segment map 614, the bitrate manager 620 determines whether the subsequent segment encoding can successfully be downloaded at the current bitrate and stored in the buffer 612 within a sufficient timeframe. As a general matter, the subsequent segment encoding needs to be downloaded and buffered before output of the current segment encoding is complete. Accordingly, in embodiments where the segment duration is two seconds, a subsequent segment encoding needs to be downloaded and buffered within two seconds or less.

Under some conditions, the bitrate manager 620 determines that the subsequent segment encoding cannot be downloaded at the current bitrate and stored in the buffer 612 within a sufficient timeframe. For example, and without limitation, if the subsequent segment encoding is very large, the download process may not complete before output of the current segment encoding is complete. Alternatively, if the subsequent segment encoding is very large, the buffer 612 may be insufficient to store all of the subsequent segment encoding.

To address such issues, the bitrate manager 620 is configured to modify the current bitrate at which the media title is streamed so that a particular encoding of the subsequent segment can successfully be downloaded and stored within the relevant timeframe. In so doing, the bitrate manager 620 computes a target bitrate for the subsequent segment based on the metrics discussed above and then reduces or “downshifts” the current bitrate by one or more levels. When requesting the subsequent segment encoding, the media player 600 issues a request for the subsequent segment encoding at the target bitrate. Under some conditions, the bitrate manager 620 can also increase or “upshift” the current bitrate by one or more levels. For example, and without limitation, if the subsequent segment encoding is very small, then the bitrate manager 620 could upshift the current bitrate, thereby causing the media player 600 to request a higher bitrate encoding of the subsequent segment. Based on the modified bitrate, and based on the segment map 614, the buffer manager 610 is configured to allocate a portion of the buffer 612 that can accommodate the subsequent segment encoding at the target bitrate. In various embodiments, the segment map 614 includes sparse size data, and the bitrate manager 620 infers an appropriate bitrate based on any available size data.

Persons skilled in the art will understand that the different techniques described above can be implemented independently of one another or in conjunction with one another. In particular, the buffer manager 610 can allocate portions of the buffer 612 for a subsequent segment encoding based on the size data 644 and/or the segment map 614 without any changes to the current bitrate. Similarly, the bitrate manager 620 can modify the bitrate based on the size data 644 and/or the segment map 614 without allocating any portions of the buffer 612 for subsequent segment encodings. However, implementing the two disclosed techniques in conjunction with one another facilitates the media player 600 in delivering continuous output of audiovisual content with a bitrate that maximizes quality.

In various embodiments, the CDN node 550 is configured to pre-cache segment encodings 630 across a range of bitrates. This approach helps to address situations where numerous endpoint devices 115 stream segment encodings associated with a given media title at a specific bitrate, but the CDN node 550 does not cache segment encodings at other bitrates. If many endpoint devices 115 then upshift or downshift bitrate suddenly, the CDN node 550 would need to retrieve segment encodings at the appropriate bitrates from an upstream location (e.g., another node 550 or the origin 540), potentially causing streaming delays. Pre-caching segment encodings helps to avoid such an issue. In addition, when a given segment encoding associated with a given bitrate is pre-cached, the CDN node 550 computes the size of that segment encoding and can then pre-load a response 640 that includes relevant size data 644. This technique increases the speed with which the CDN node 550 can respond to requests from endpoint devices 115.

In addition, in live streaming configurations, when the CDN node 550 services requests for a current segment, the CDN node 550 can pre-cache segment encodings 630 associated with a subsequent segment and, additionally, pre-load responses 640 associated with those segments. This approach can be implemented when streaming at a live edge corresponding to a present moment in time, or when endpoint devices 115 reverse playback to a previous moment in time. For example, and without limitation, suppose an endpoint device 115 requests a segment encoding with segment index 100 from the CDN node 550. The CDN node 550, in response, could pre-cache a segment encoding with segment index 101. Suppose then that the endpoint device 115 reverses playback to a playback position associated with segment index 50. The CDN node 550, in response, could pre-cache a segment encoding with segment index 51 (if needed) and generate size data corresponding to one or more segment encodings with segment index 52. These techniques can further expedite the ability of the CDN node 550 to respond to requests from endpoint devices 115.

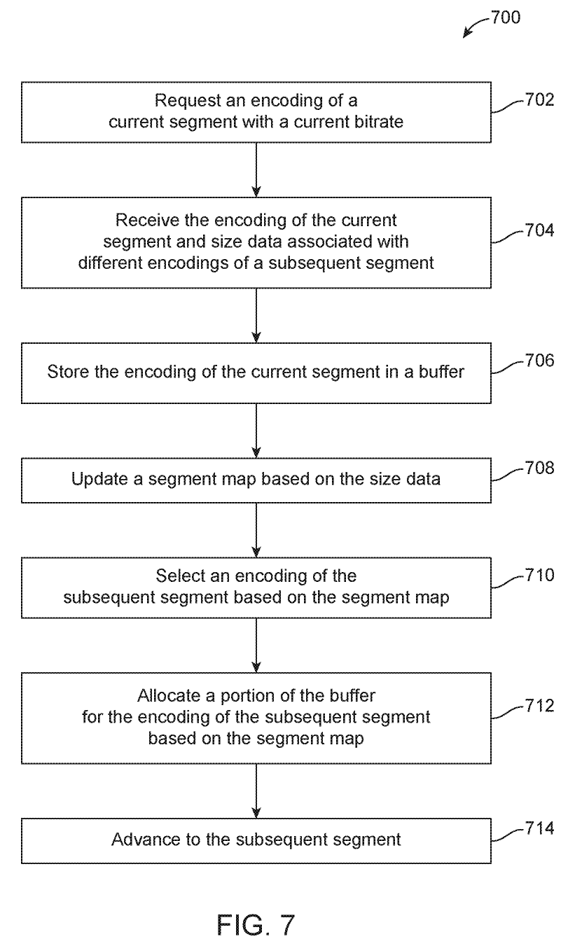

FIG. 7 is a flow diagram of method steps for using segment size information when requesting segments of audiovisual content, according to various embodiments. Although the method steps are described in conjunction with the systems of FIGS. 1-6, persons skilled in the art will understand that any system configured to perform the method steps, in any order, is within the scope of the present invention.

As shown, a method 700 begins at step 702, where the media player 600 requests an encoding of a current segment with a current bitrate. During streaming of a given media title, the endpoint device 115 requests encodings of sequential segments of audiovisual content. A given segment of audiovisual content can have any duration, although in live streaming configurations each segment may have a two-second duration. The CDN nodes 550 include different encodings of each segment at various bitrates, thereby facilitating adaptive streaming.

At step 704, the media player 600 receives the encoding of the current segment along with size data 644 associated with different encodings of a subsequent segment. The size data 644 includes sizes of some or all encodings of the subsequent segment of audiovisual content. The CDN node 550 determines the size of the different encodings by evaluating a subsequent set of segment encodings 630. In some instances, a given set of segment encodings 630 may not yet include segment encodings at each possible bitrate. For example, and without limitation, certain segment encodings at higher bitrates may not yet be available when the CDN node 550 extracts the size data 644. Accordingly, the size data 644 can, in some instances, be a sparse representation of all possible encodings.

At step 706, the buffer manager 610 within the media player 600 stores the encoding of the current segment in the buffer 612. In doing so, the buffer manager 610 prepares the encoding of the current segment to be output by the display device 450. In various embodiments, the buffer manager 610 allocates a portion of the buffer 612 for storing the encoding of the current segment when outputting audiovisual content associated with a previous segment.

At step 708, the buffer manager 610 updates the segment map 614 based on the size data 644. The segment map 614 includes an array of sizes corresponding to each encoding for any given segment. The buffer manager 610 updates the segment map 614 as various size data is received during streaming so that size data for any given segment can be used when requesting encodings of such segments. For example, and without limitation, if the media player 600 reverses playback to a previous position corresponding to a particular segment, the buffer manager 610 could access size data associated with that particular segment in order to configure the endpoint device 115 for receiving encodings of that segment.

At step 710, the bitrate manager 620 selects an encoding of the subsequent segment based on the segment map 614. In particular, the bitrate manager 620 evaluates the segment map 614 based on various metrics that represent network conditions and/or operational characteristics of the media player 600 and/or endpoint device 115. The bitrate manager 620 then selects a particular bitrate that allows the segment encoding corresponding to that bitrate to be downloaded and buffered fast enough to ensure that streaming continues without delay. In this manner, the bitrate manager 620 helps to avoid situations where an encoding of a subsequent segment at the current bitrate is too large to download in time or too large to buffer with current memory resources.

At step 712, the buffer manager 610 allocates a portion of the buffer 612 for the encoding of the subsequent segment based on the segment map 614. The buffer manager 610 uses the size data 644 stored in the segment map 614 to determine how much buffer space is needed to store the selected segment encoding. Certain endpoint devices 115 need to allocate buffer space before issuing a request for an encoding of a given segment. Allocating buffer space based on size data 644 from the segment map 614 received in conjunction with an encoding of a previous segment allows such endpoint devices 115 to avoid needing to make a separate size request.

At step 714, the media player 600 advances to the subsequent segment and repeats the method 700. Because the buffer manager 610 has already allocated sufficient buffer space for the encoding selected at step 710, and because the bitrate manager 620 has determined a bitrate that allows a successful download within the relevant timeframe, streaming may continue in an uninterrupted manner.

Referring generally to FIGS. 6-7, the techniques described above allow endpoint devices to perform one or more operations based on size data associated with a subsequent segment prior to requesting audiovisual content associated with the subsequent segment and/or during output of a current segment of audiovisual content. The one or more operations can include, for example and without limitation, allocating buffer space or modifying streaming bitrate, among others. Performing such operations in advance of requesting the audiovisual content permits the endpoint devices to optimize usage of various resources while maximizing the quality of audiovisual content that is output to users.

In sum, an endpoint device issues a request for an encoding of a current segment of audiovisual content and receives, in response, the requested encoding along with size data associated with various encodings of a subsequent segment of audiovisual content at different bitrates. The endpoint device can then allocate buffer space for an encoding of the subsequent segment of audiovisual content before issuing a request for the encoding. The size data indicates several different sizes for several different encodings of the subsequent segment corresponding to several different bitrates. Based on current network conditions and currently available storage resources, the endpoint device can select an appropriate encoding of the subsequent segment to request that minimizes network latency, optimizes buffer usage, and maximizes streaming quality. In various embodiments, the endpoint device can select a particular encoding of the subsequent segment first, modify the current bitrate as needed, and then allocate the buffer space to accommodate downloading and buffering the encoding of the subsequent segment at the modified bitrate.

At least one technical advantage of the disclosed techniques relative to the prior art is that the disclosed techniques enable endpoint devices to avoid having to transmit multiple requests for each segment of audiovisual content. Accordingly, network bandwidth and processing resources need not be wasted issuing superfluous requests. Another technical advantage of the disclosed techniques relative to the prior art is that endpoint devices can more effectively select between different encodings of segments of audiovisual content at different bitrates, thereby allowing endpoint devices to maximize streaming quality while reducing the risk of rebuffering. Yet another technical advantage of the disclosed technique is that information can be conveyed to endpoint devices that there is a discontinuity in the playback stream (e.g., caused by a temporary failure of the encoding pipelines, or source feed, etc.). As such, the media player can be instructed that the next N segment(s) are not available, and that the next request issued by the endpoint device should be N segments hence. These technical advantages provide one or more technological advancements over prior art approaches.
1. Some embodiments include a computer-implemented method for updating configurations of endpoint devices when streaming media titles, the method comprising receiving a first encoding derived from a first segment of audiovisual content in conjunction with receiving size data corresponding to one or more encodings of a second segment of audiovisual content, and updating a configuration of an endpoint device to cause the endpoint device to receive a second encoding derived from the second segment of audiovisual content based on the size data when streaming a media title.
2. The computer-implemented method of clause 1, wherein updating the configuration of the endpoint device comprises allocating a portion of a buffer for storing the second encoding, and issuing a request for the second encoding.
3. The computer-implemented method of any of clauses 1-2, wherein updating the configuration of the endpoint device comprises computing a target bitrate based on the size data and based on one or more operational characteristics of the endpoint device, and selecting the second encoding based on the target bitrate.
4. The computer-implemented method of any of clauses 1-3, wherein a first bitrate associated with the first encoding is greater than a second bitrate associated with the second encoding, and wherein the size data indicates that the first encoding has a smaller size than the second encoding.
5. The computer-implemented method of any of clauses 1-4, wherein updating the configuration of the endpoint device comprises modifying a bitrate at which the endpoint device streams the media title.
6. The computer-implemented method of any of clauses 1-5, wherein a first bitrate associated with the first encoding is less than a second bitrate associated with the second encoding, and wherein the size data indicates that the first encoding has a larger size than the second encoding.
7. The computer-implemented method of any of clauses 1-6, wherein the media title comprises at least the first segment of audiovisual content and the second segment of audiovisual content.
8. The computer-implemented method of any of clauses 1-7,wherein configuring the endpoint device to receive the second encoding occurs in conjunction with the endpoint device outputting the first segment of audiovisual content.
9. The computer-implemented method of any of clauses 1-8, further comprising transmitting a response to the endpoint device that includes the first encoding and the size data in response to a request received from the endpoint device, wherein the response is pre-loaded before the request is received.
10. The computer-implemented method of any of clauses 1-9, further comprising pre-caching the second encoding in response to receiving a request for the first encoding.
11. Some embodiments include one or more non-transitory computer-readable media including instructions that, when executed by one or more processors, cause the one or more processors to update configurations of endpoint devices when streaming media titles, by performing the steps of receiving a first encoding derived from a first segment of audiovisual content in conjunction with receiving size data corresponding to one or more encodings of a second segment of audiovisual content, and updating a configuration of an endpoint device to cause the endpoint device to receive a second encoding derived from the second segment of audiovisual content based on the size data when streaming a media title.
12. The one or more non-transitory computer-readable media of clause 11, wherein the step of updating the configuration of the endpoint device comprises allocating a portion of a buffer for storing the second encoding, and issuing a request for the second encoding.
13. The one or more non-transitory computer-readable media of any of clauses 11-12, wherein the step of updating the configuration of the endpoint device comprises computing a target bitrate based on the size data and based on one or more operational characteristics of the endpoint device, and selecting the second encoding based on the target bitrate.
14. The one or more non-transitory computer-readable media of any of clauses 11-13, wherein a first bitrate associated with the first encoding is greater than a second bitrate associated with the second encoding, and wherein the size data indicates that the first encoding has a smaller size than the second encoding.
15. The one or more non-transitory computer-readable media of any of clauses 11-14, wherein the step of updating the configuration of the endpoint device comprises modifying a bitrate at which the endpoint device streams the media title.
16. The one or more non-transitory computer-readable media of any of clauses 11-15, wherein a first bitrate associated with the first encoding is less than a second bitrate associated with the second encoding, and wherein the size data indicates that the first encoding has a larger size than the second encoding.
17. The one or more non-transitory computer-readable media of any of clauses 11-16, wherein the media title comprises at least the first segment of audiovisual content and the second segment of audiovisual content.
18. The one or more non-transitory computer-readable media of any of clauses 11-17, further comprising the step of updating a segment map based on the size data, wherein the segment map indicates different sizes of different encodings associated with different segments of audiovisual content.
19. The one or more non-transitory computer-readable media of any of clauses 11-18, wherein the media title corresponds to a live event occurring in real time, wherein the first segment of audiovisual content corresponds to a first duration of time, and wherein the second segment of audiovisual content corresponds to the first duration of time.
20. Some embodiments include a system comprising one or more memories storing instructions, and one or more processors coupled to the one or more memories that, when executing the instructions, perform the steps of receiving a first encoding derived from a first segment of audiovisual content in conjunction with receiving size data corresponding to one or more encodings of a second segment of audiovisual content, and updating a configuration of an endpoint device to cause the endpoint device to receive a second encoding derived from the second segment of audiovisual content based on the size data when streaming a media title.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for updating configurations of endpoint devices when streaming media titles, the method comprising:
receiving a first encoding derived from a first segment of audiovisual content in conjunction with receiving size data corresponding to one or more encodings of a second segment of audiovisual content; and
updating a configuration of an endpoint device to cause the endpoint device to receive a second encoding derived from the second segment of audiovisual content based on the size data when streaming a media title.

2. The computer-implemented method of claim 1, wherein updating the configuration of the endpoint device comprises:
allocating a portion of a buffer for storing the second encoding; and
issuing a request for the second encoding.

3. The computer-implemented method of claim 1, wherein updating the configuration of the endpoint device comprises:
computing a target bitrate based on the size data and based on one or more operational characteristics of the endpoint device; and
selecting the second encoding based on the target bitrate.

4. The computer-implemented method of claim 1, wherein a first bitrate associated with the first encoding is greater than a second bitrate associated with the second encoding, and wherein the size data indicates that the first encoding has a smaller size than the second encoding.

5. The computer-implemented method of claim 1, wherein updating the configuration of the endpoint device comprises modifying a bitrate at which the endpoint device streams the media title.

6. The computer-implemented method of claim 1, wherein a first bitrate associated with the first encoding is less than a second bitrate associated with the second encoding, and wherein the size data indicates that the first encoding has a larger size than the second encoding.

7. The computer-implemented method of claim 1, wherein the media title comprises at least the first segment of audiovisual content and the second segment of audiovisual content.

8. The computer-implemented method of claim 1,wherein configuring the endpoint device to receive the second encoding occurs in conjunction with the endpoint device outputting the first segment of audiovisual content.

9. The computer-implemented method of claim 1, further comprising transmitting a response to the endpoint device that includes the first encoding and the size data in response to a request received from the endpoint device, wherein the response is pre-loaded before the request is received.

10. The computer-implemented method of claim 1, further comprising pre-caching the second encoding in response to receiving a request for the first encoding.

11. One or more non-transitory computer-readable media including instructions that, when executed by one or more processors, cause the one or more processors to update configurations of endpoint devices when streaming media titles, by performing the steps of:
receiving a first encoding derived from a first segment of audiovisual content in conjunction with receiving size data corresponding to one or more encodings of a second segment of audiovisual content; and
updating a configuration of an endpoint device to cause the endpoint device to receive a second encoding derived from the second segment of audiovisual content based on the size data when streaming a media title.

12. The one or more non-transitory computer-readable media of claim 11, wherein the step of updating the configuration of the endpoint device comprises:
allocating a portion of a buffer for storing the second encoding; and
issuing a request for the second encoding.

13. The one or more non-transitory computer-readable media of claim 11, wherein the step of updating the configuration of the endpoint device comprises:
computing a target bitrate based on the size data and based on one or more operational characteristics of the endpoint device; and
selecting the second encoding based on the target bitrate.

14. The one or more non-transitory computer-readable media of claim 11, wherein a first bitrate associated with the first encoding is greater than a second bitrate associated with the second encoding, and wherein the size data indicates that the first encoding has a smaller size than the second encoding.

15. The one or more non-transitory computer-readable media of claim 11, wherein the step of updating the configuration of the endpoint device comprises modifying a bitrate at which the endpoint device streams the media title.

16. The one or more non-transitory computer-readable media of claim 11, wherein a first bitrate associated with the first encoding is less than a second bitrate associated with the second encoding, and wherein the size data indicates that the first encoding has a larger size than the second encoding.

17. The one or more non-transitory computer-readable media of claim 11, wherein the media title comprises at least the first segment of audiovisual content and the second segment of audiovisual content.

18. The one or more non-transitory computer-readable media of claim 11, further comprising the step of updating a segment map based on the size data, wherein the segment map indicates different sizes of different encodings associated with different segments of audiovisual content.

19. The one or more non-transitory computer-readable media of claim 11, wherein the media title corresponds to a live event occurring in real time, wherein the first segment of audiovisual content corresponds to a first duration of time, and wherein the second segment of audiovisual content corresponds to the first duration of time.

20. A system comprising:
one or more memories storing instructions; and
one or more processors coupled to the one or more memories that, when executing the instructions, perform the steps of:
receiving a first encoding derived from a first segment of audiovisual content in conjunction with receiving size data corresponding to one or more encodings of a second segment of audiovisual content, and
updating a configuration of an endpoint device to cause the endpoint device to receive a second encoding derived from the second segment of audiovisual content based on the size data when streaming a media title.
